(19) United States
(12) Patent Application Publication
(10) Pub. No.: US 2023/0107982 A1
(43) Pub. Date: Apr. 6, 2023

(54) FORCE LIMITATION IN THE EVENT OF COLLISION OF A ROBOT MANIPULATOR

(71) Applicant: Franka Emika GmbH, München (DE)

(72) Inventor: Andreas Spenninger, Karlsfeld (DE)

(21) Appl. No.: 17/794,501

(22) PCT Filed: Feb. 10, 2021
(86) PCT No.: PCT/EP2021/053129

§ 371 Date: Jul. 21, 2022

(30) Foreign Application Priority Data
Feb. 14, 2020 (DE) 10 2020 103 857.7

(51) Int. Cl. B25J 9/16

(52) U.S. Cl. CPC B25J 9/1633; B25J 9/1666

(57) ABSTRACT

A method of operating a robot manipulator, the method including: specifying a maximum permissible force to be exerted on an object by the robot manipulator, specifying a target position of a reference point of the robot manipulator, determining a current position of the reference point, performing an impedance regulation, which determines a current reference force of an artificial spring component based on a spring stiffness and based on a difference between the current position and the target position of the reference point of the robot manipulator, and controlling the robot manipulator to execute an emergency control program if the current reference force exceeds the maximum permissible force.

### CROSS-REFERENCE TO RELATED APPLICATIONS

The present application is the U.S. National Phase of PCT/EP2021/053129, filed on 10 Feb. 2021, which claims priority to German Patent Application No. 10 2020 103 857.7, filed on 14 Feb. 2020, the entire contents of which are incorporated herein by reference.

### BACKGROUND

### Field

The invention relates to a method for operating a robot manipulator and a corresponding robot system.

### SUMMARY

The object of the invention is to improve safety when operating a robot manipulator.

The invention results from the features of the independent claims. Advantageous refinements and embodiments are the subject matter of the dependent claims.

A first aspect of the invention relates to a method of operating a robot manipulator, the method including:
specifying a maximum permissible force to be exerted on an object by the robot manipulator in a vicinity of the robot manipulator;
specifying a target position of a reference point of the robot manipulator;
determining a current position of the reference point of the robot manipulator;
controlling the robot manipulator by performing an impedance regulation, wherein the impedance regulation has an artificial spring component and a current reference force of the artificial spring component is determined based on a specified spring stiffness and based on a difference between the current position and target position of the reference point of the robot manipulator; and
controlling the robot manipulator to execute an emergency control program if the current reference force exceeds the maximum permissible force.

All steps of the method according to the first aspect of the invention are preferably carried out by a control unit of the robot manipulator. In particular, the control unit has corresponding interfaces and at least one computing unit in order to carry out the corresponding steps. The current position of the reference point of the robot manipulator is also determined, in particular, with the aid of position determination means, in particular, position sensors. The position determination means preferably include at least one of the following: joint angle sensors of the robot manipulator; external camera unit; sensor fusion unit for sensor data fusion of the data from joint angle sensors of the robot manipulator and the data from the external camera unit; redundant joint angle sensors of the robot manipulator.

The object from the environment of the robot manipulator can be a workpiece or another object, or a living organism, in particular, a human being.

The term “maximum permissible force”, which describes the maximum permissible force to be exerted by the robot manipulator on an object in the vicinity of the robot manipulator, is in principle interchangeable with the term “maximum permissible pressure” that may be exerted on the object. The terms of force and pressure differ only in terms of a surface area; while the notion of force indicates the absolute load on the object by the robot manipulator without reference to the distribution of the force on the object, the notion of pressure considers a corresponding contact area over which the maximum permissible force is transmitted. In this respect, pressure and force can be converted into one another at any time, with the reference area of the contact pressure being determined, in particular, by assuming that it is determined that a structural portion of the robot manipulator is in full contact with the object in its surroundings. A conservative assumption used as an alternative to the previous assumption of the reference surface is the assumption of the surface of a protruding geometry of the portion of the robot manipulator, for example, an edge, a shell segment, or other protruding parts of the respective structural portion of the robot manipulator.

The robot manipulator itself has, in particular, a large number of links connected to one another by joints, wherein actuators, preferably electric motors, allow corresponding control and mobility of the robot manipulator at the joints of the robot manipulator. Furthermore, an end effector is preferably arranged at the distal end of the robot manipulator, which end effector is used to carry out a task such as, for example, machining a workpiece. The term reference point of the robot manipulator used below and above is preferably to be understood as a predefined location on the robot manipulator, particularly preferably on the end effector of the robot manipulator. The reference point of the robot manipulator is thus at all times thought to be physically fixed on the body of the robot manipulator and, in particular, on the end effector of the robot manipulator.

The current position of the reference point of the robot manipulator indicates, in particular, where the reference point of the robot manipulator is located, in particular, in relation to a fixed coordinate system or a coordinate system fixed to the base or a pedestal of the robot manipulator. In other words, the position of the reference point therefore designates a position in space and indicates, in particular, how the reference point of the robot manipulator moves in space or where it is currently located.

According to the first aspect of the invention, the robot manipulator is controlled by impedance regulation, in particular, when executing a task. The result of the implementation of the impedance regulation is a target variable that has corresponding command variables for the actuators of the robot manipulator. An impedance regulation has at least one artificial spring component. Furthermore, the impedance regulation can have an artificial dampening component that generates a resistance force that opposes a current speed. The artificial spring component generates a correlation between a deflection of the reference point from a predetermined target position and a restoring force associated with the deflection. This restoring force is referred to above and below as the reference force of the artificial spring component. There is thus a clear connection between deflection and force. The higher the deflection from the target position, the higher the reference force. The reference force is aligned in a restoring manner, so that when it is released after the reference point has been deflected from the target position, the reference force has a restoring effect in the direction of the target position.

The target position can be specified statically in relation to a coordinate system that is, in particular, fixed, that is to say fixed in space and immobile. As an alternative to this, the target position can be understood in the sense of a momentary consideration of a sequence of a large number of target positions. In the latter case, the reference point of the robot manipulator moves on a predetermined path, with each position on the predetermined path ideally also corresponding to a position of the reference point at a particular point in time. A deflection from the target position in the case of a specified movement path can on the one hand correspond to the simple case that the deflection is considered from a fixed target position of the specified path considered in space, or alternatively preferably as a current deflection from the target position continuously moved along the path. In the latter case, the path is not only defined by a group of predefined locations in space, but time information is also assigned to the predefined locations, so that the predefined path can be referred to as a predefined trajectory. A deflection from the specified trajectory accordingly includes a deflection from the target point present at a current point in time at its current location on the specified path.

If the force determined from this deflection exceeds the specified maximum permissible force, the robot manipulator is controlled with an emergency control program.

It is therefore an advantageous effect of the invention that it is checked solely based on position information, in particular, from position sensors, as to whether a maximum permissible force is being exceeded. The force sensors and/or torque sensors, which are more difficult to handle from a safety-critical point of view, are not necessary for checking the maximum permissible force. It is advantageous to use redundant information to check whether the maximum permissible force exerted by the robot manipulator on the object is exceeded by redundant position determination means that are easy to implement, in particular, position sensors.

According to an advantageous embodiment, the emergency control program includes at least one of the following control programs: stopping the robot manipulator, moving the robot manipulator back to its original path, switching to an alternative controller mode, in particular, to an admittance regulation and/or a gravitational force-compensated mode, by ending all movement and/or force commands.

According to a further advantageous embodiment, the maximum permissible force is specified by detecting an input from a user at a user interface. The user interface is, in particular, a touch-sensitive screen, a screen whose elements can be operated with a keyboard and/or mouse, buttons, switches, voice control, or the like.

According to a further advantageous embodiment, the maximum permissible force is specified using a database, a large number of body zones of a person with a respective associated maximum permissible force with regard to one of the body zones being stored in the database. The database is stored, in particular, on a central computer unit, so that, in particular, a control unit of the robot manipulator can obtain data from the database via a corresponding interface. The body zones are defined, in particular, in relation to surface zones of a human body, for example, the front of the thighs, the back of the thighs, the face, the chest, etc. According to this embodiment, the maximum permissible force is assigned to the respective body zones, so that in the event of a collision of the robot manipulator with a corresponding body zone, different maximum permissible forces may also be applied by the robot manipulator to the person's body. This embodiment advantageously takes into account the fact that different body zones of a human person are also differently sensitive to force and pressure.

According to a further advantageous embodiment, a maximum permissible force is selected based on camera-based detection of a collision between a specific body zone of the person and the robot manipulator, with the colliding body zone of the person being assigned to a body zone stored in the database and the maximum permissible force associated with the assigned body zone being selected. The advantage of a camera-based detection of a collision is the easy detection of the colliding body zone of the person with the robot manipulator. Depending on this colliding body zone of the person, the associated maximum permissible force can advantageously be determined from the database with little effort.

According to a further advantageous embodiment, all the maximum permissible forces in the database or the selected one of the maximum permissible forces are adapted depending on an edge geometry of the robot manipulator and/or depending on a task or task class to be performed by the robot manipulator. The adjustment is, in particular, a reduction in the maximum permissible force or forces when the edges of the robot manipulator are more pointed and become sharper. Such more pointed and sharper edges of the robot manipulator are more uncomfortable for a person in a collision of the robot manipulator with this person as compared to blunt and round geometries of the robot manipulator, as well as easily damage an object as an object in a collision of the robot manipulator with this object. There are the following two options for adjustment: In the first variant, which is less computationally intensive, a body zone affected by the collision and the associated maximum permissible force are first selected from the database and this selected force is adjusted. In the second variant, all entries in the database are continuously adjusted so that the value selected in the database of the permissible force for the person's body zone currently in question does not have to be adjusted further and can be adopted unchanged.

According to a further advantageous embodiment, the target position is specified by specifying a desired path of the reference point of the robot manipulator. Specifying the desired path of the reference point of the robot manipulator can be understood as specifying a large number of target positions, but more expediently as the course of a single target position over the desired path, with the desired path together with specified time information being referred to as the desired trajectory. In the latter case, the deflection from the target position always refers to the deflection from the current target position on the desired trajectory of the reference point. Advantageously, the method for checking whether the maximum permissible force is exceeded can also be carried out while a desired path is being traversed by the reference point of the robot manipulator, in particular, in such a way that an unintentional or unplanned stopping of the robot manipulator in relation to the reference force is also detected, because then the location of the target position continues on the desired path while the robot manipulator is forced to stand still or is decelerated—which inevitably leads to an increasing deflection of the reference point from the target position until the reference force exceeds the maximum permissible force and the emergency control program is executed.

According to a further advantageous embodiment, the current position of the reference point of the robot manipulator is determined based on redundant sensor signals. Redundant sensor signals can on the one hand be supplied by sensors of the same type, for example, multiple position sensors on joints of the robot manipulator. However, the concept of redundant sensor signals does not exclude different measurement principles, so that, for example, the measurements from joint angle sensors on the joints of the robot manipulator can also be fused with sensor signals from an external camera unit, wherein the external camera unit's detection area preferably completely encompasses the surroundings of the robot manipulator and the entire robot manipulator itself.

According to a further advantageous embodiment, the target position of the reference point of the robot manipulator is specified behind a surface of the object, so that the robot manipulator exerts a force on the surface of the object in the direction of the target position. This embodiment is suitably applied particularly to a material object as an object to which a force is intended to be applied by the robot manipulator. However, without using force sensors and/or moment sensors for force regulation, according to this embodiment, the strategy mentioned above and in the following is used with the aid of impedance regulation in order to infer a corresponding reference force based on the deflection of the reference point of the robot manipulator from the target position of the reference point. If the surface of the object (also referred to as the material object above) is approached, i.e., the target point is moved further and further in the direction of the object, contact between the robot manipulator and the object occurs at a certain point. If the target point continues to be virtually moved behind the surface of the object, the robot manipulator cannot follow due to the resistance on the surface of the object and a deflection builds up between the current position of the reference point of the robot manipulator, which is on the surface of the object, and the further traversed target position of the reference point. As a result, the robot manipulator applies a force to the object. If this force (which is the reference force) exceeds the maximum allowable force, the emergency control program will be executed. This embodiment advantageously offers the possibility of also exerting desired forces on an object by the robot manipulator.

Another aspect of the invention relates to a robot system, having a robot manipulator and a control unit connected to the robot manipulator, wherein the control unit is designed to specify a maximum permissible force that may be exerted by the robot manipulator on an object in an area surrounding the robot manipulator, for specifying a target position of a reference point of the robot manipulator, to determine a current position of the reference point of the robot manipulator, to control the robot manipulator by carrying out an impedance regulation, the impedance regulation having an artificial spring component and a current reference force of the artificial spring component is determined based on a predetermined spring stiffness and based on the difference between the current position and the specified target position of the reference point of the robot manipulator, and for controlling the robot manipulator to execute an emergency control program if the current reference force exceeds the predetermined maximum permissible force.

Advantages and preferred refinements of the proposed robot system result from an analogous and corresponding transfer of the statements made above in conjunction with the proposed method.

Further advantages, features, and details will be apparent from the following description, in which—possibly with reference to the drawings—at least one example embodiment is described in detail. The same, similar, and/or functionally identical parts are provided with the same reference numerals.

### BRIEF DESCRIPTION OF THE DRAWINGS

In the drawings:

FIG. 1 shows a method according to an exemplary embodiment of the invention; and

FIG. 2 shows a robot system used to carry out the method according to FIG. 1.

The illustrations in the figures are schematic and not to scale.

### DETAILED DESCRIPTION

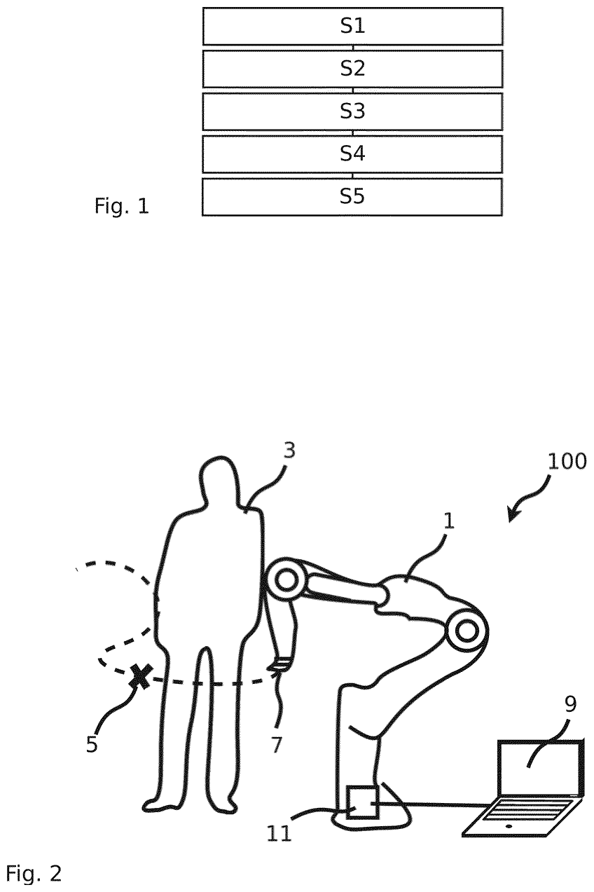

FIG. 1 shows a method of operating a robot manipulator 1, the method including:
specifying S1 a maximum permissible force to be exerted on an object 3 by the robot manipulator 1 in the vicinity of the robot manipulator 1;
specifying S2 a target position 5 of a reference point 7 of the robot manipulator 1;
determining S3 a current position of the reference point 7 of the robot manipulator 1;
controlling S4 the robot manipulator 1 by performing an impedance regulation, wherein the impedance regulation has an artificial spring component and a current reference force of the artificial spring component is determined based on a specified spring stiffness and based on a difference between the current position and the target position 5 of the reference point 7 of the robot manipulator 1; and
controlling S5 the robot manipulator 1 to execute an emergency control program if the current reference force exceeds the maximum permissible force.

The method as described in this FIG. 1 is performed on a robot system 100 in FIG. 2. The reference symbols identified above, which are not to be found in FIG. 1, therefore refer directly to FIG. 2. The method is explained in more detail below with reference to the robot system 100 of FIG. 2.

FIG. 2 shows a robot system 100 for carrying out the method of FIG. 1. The robot system 100 has a robot manipulator 1 and a control unit 11 connected to the robot manipulator 1. The control unit 11 specifies a maximum permissible force to be exerted by the robot manipulator 1 on an object 3, here specifically the body zone of the person 3 affected by a collision with a person 3. In this case, a collision is first detected by torque sensors in the joints of the robot manipulator 1. In contrast, the affected body zone is determined camera-based, i.e., based on an external camera system (not shown in FIG. 2). In the present example, this is the elbow of person 3. The control unit 11 queries a database as to the maximum permissible force that may be applied to the elbow of person 3. This maximum permissible force of the database is specified by the user via a user interface 9. The user interface 9 is a user computer that is connected to the control unit 11 of the robot manipulator 1. The corresponding body zone, namely the elbow of person 3, is assigned a corresponding maximum permissible force in the database. This maximum permissible force is read out. Since the control unit 11 is also designed to specify a current target position 5 of a reference point 7 of the robot manipulator 1, the collision causes an increasing deflection of the current position of the reference point 7 of the robot manipulator 1, which is thought to be arranged on the end effector of the robot manipulator 1. This continuous target position 5 of the reference point 7 continues accordingly on its specified trajectory. This current position of the reference point 7 of the robot manipulator 1 is continuously determined by the control unit 11. Moreover, the robot manipulator 1 is controlled by its control unit 11 by performing an impedance regulation, wherein the impedance regulation has an artificial spring component and a current reference force of the artificial spring component is determined based on a specified spring stiffness and based on a difference between the current position and the specified target position 5 of the reference point 7 of the robot manipulator 1. If this reference force exceeds the maximum permissible force associated with the body zone affected by the collision, the emergency control program is executed. The emergency control program includes a brief return of the robot manipulator on its path executed up to the collision, and then stopping the entire robot manipulator 1 in its current pose.

Although the invention has been further illustrated and described in detail by way of preferred example embodiments, the invention is not limited by the disclosed examples, and other variations can be derived therefrom by a person skilled in the art without departing from the scope of protection of the invention. It is therefore obvious that several possible variations exist. It is also clear that illustrated embodiments are really only examples, which are not to be construed in any way as limiting the scope of protection, applicability, or configuration of the invention. Rather, the foregoing description and the description of the figures enable a person skilled in the art to concretely implement the example embodiments, and such person may make various changes based on the knowledge of the disclosed inventive concept, for example, with respect to the function or arrangement of individual elements cited in an example embodiment, without departing from the scope as defined by the claims and their legal equivalents, such as a more extensive explanation in the description.

### LIST OF REFERENCE NUMERALS

1 robot manipulator
3 object
5 target position
7 reference point
9 user interface
11 control unit
100 robot system
S1 specifying
S2 specifying
S3 determining
S4 controlling
S5 controlling

1. A method of operating a robot manipulator the method comprising:
specifying a maximum permissible force to be exerted by the robot manipulator on an object in a vicinity of the robot manipulator;
specifying a target position of a reference point of the robot manipulator;
determining a current position of the reference point of the robot manipulator;
controlling the robot manipulator by performing an impedance regulation, wherein the impedance regulation has an artificial spring component, and a current reference force of the artificial spring component is determined based on a specified spring stiffness and based on a difference between the current position and the target position of the reference point of the robot manipulator; and
controlling the robot manipulator to execute an emergency control program if the current reference force exceeds the maximum permissible force.

2. The method of claim 1, wherein the emergency control program includes at least one of the following control programs: stopping the robot manipulator, moving the robot manipulator back to its original path, and switching to an alternative regulation mode.

3. The method of claim 1, wherein specifying the maximum permissible force is comprises detecting an input of a user at a user interface.

4. The method of claim 1, wherein specifying the maximum permissible force comprises using a database, wherein a plurality of body zones of a person with a respective associated maximum permissible force with respect to one of the body zones is stored in the database.

5. The method of claim 4, wherein specifying the maximum permissible force comprises:
performing camera-based detection of a collision between a specific body zone of the person and the robot manipulator; and
selecting the maximum permissible force from the database based on the detection of the collision between the specific body zone of the person and the robot manipulator, wherein the specific body zone of the person is assigned to a body zone stored in the database and a maximum permissible force associated with the body zone assigned is selected as the maximum permissible force.

6. The method of claim 4, wherein the method comprises adapting maximum permissible forces stored in the database or one selected from the maximum permissible forces depending on an edge geometry of the robot manipulator and/or a task or task class to be performed by the robot manipulator.

7. The method of claim 1, wherein specifying the target position comprises specifying a desired path of the reference point of the robot manipulator.

8. The method of claim 1, wherein determining the current position of the reference point of the robot manipulator is based on redundant sensor signals.

9. The method of claim 1, wherein the target position of the reference point of the robot manipulator is specified behind a surface of the object, such that the robot manipulator exerts a force on the surface of the object in a direction of the target position.

10. (canceled)

11. The method of claim 2, wherein the alternative regulation mode is an admittance regulation mode and/or a gravitational force-compensated mode, and the switching to the alternative regulation mode includes ending all movement and/or force commands.

12. A robot system comprising:
a robot manipulator; and
a control unit connected to the robot manipulator, the control unit configured to:
specify a maximum permissible force to be exerted by the robot manipulator on an object in a vicinity of the robot manipulator;
specify a target position of a reference point of the robot manipulator;
determine a current position of the reference point of the robot manipulator;
control the robot manipulator by performing an impedance regulation, wherein the impedance regulation has an artificial spring component and a current reference force of the artificial spring component is determined based on a specified spring stiffness and based on a difference between the current position and the target position of the reference point of the robot manipulator; and
control the robot manipulator in order to execute an emergency control program if the current reference force exceeds the maximum permissible force.

13. The robot system of claim 12, wherein the emergency control program includes at least one of the following control programs: stopping the robot manipulator, moving the robot manipulator back to its original path, and switching to an alternative regulation mode.

14. The robot system of claim 12, wherein the maximum permissible force is specified by detection of an input of a user at a user interface.

15. The robot system of claim 12, wherein the maximum permissible force is specified using a database, wherein a plurality of body zones of a person with a respective associated maximum permissible force with respect to one of the body zones is stored in the database.

16. The robot system of claim 15, wherein a maximum permissible force is selected based on camera-based detection of a collision between a specific body zone of the person and the robot manipulator, wherein the specific body zone of the person is assigned to a body zone stored in the database and a maximum permissible force associated with the body zone assigned is selected as the maximum permissible force.

17. The robot system of claim 15, wherein maximum permissible forces stored in the database or one selected from the maximum permissible forces are adapted depending on an edge geometry of the robot manipulator and/or a task or task class to be performed by the robot manipulator.

18. The method of claim 12, wherein the target position is specified by specifying a desired path of the reference point of the robot manipulator.

19. The robot system of claim 12, wherein the current position of the reference point of the robot manipulator is determined based on redundant sensor signals.

20. The robot system of claim 12, wherein the target position of the reference point of the robot manipulator is specified behind a surface of the object, such that the robot manipulator exerts a force on the surface of the object in a direction of the target position.

21. The robot system of claim 13, wherein the alternative regulation mode is an admittance regulation mode and/or a gravitational force-compensated mode, and the switching to the alternative regulation mode includes ending all movement and/or force commands.
